(19) United States
(12) Patent Application Publication
(10) Pub. No.: US 2012/0174800 A1
(43) Pub. Date: Jul. 12, 2012

(54) INDEPENDENT STIRRING COOKING RECEPTACLE

(76) Inventors: VALORIE MONTAVY, Kansas City, MO (US); Michael Montavy, Kansas City, MO (US)

(21) Appl. No.: 12/985,440

(22) Filed: Jan. 6, 2011

(51) Int. Cl. A23L 1/00

(52) U.S. Cl. 99/348

(57) ABSTRACT

An independent stirring cooking receptacle comprising a cooking container, where the cooking container receives a plurality of ingredients; a lid covering a top portion of the cooking container; a motor positioned above the lid; a rod extending from the motor and through a hole within the lid, where the rod is rotated by the motor; a stir shaft attached to a bottom portion of the rod, where the stir shaft rotates as the rod rotates; a stirring means attached to the stir shaft, where the stirring means mixes the plurality of ingredients; and a paddle fastened to a bottom portion of the stir shaft, where the paddle slides against a bottom of the cooking container and wherein the motor, the stirring means and the paddle enable the plurality of ingredients to mix without a user.

### BACKGROUND OF THE INVENTION

1. Field of the Invention

The present invention relates to a motorized device that enables a cooking container to stir itself without the assistance of a user.

2. Description of Related Art

On the market there are a wide variety appliances and tools available for consumers that assist in cuisine preparation. The tools may aid in every aspect of cooking ranging from pitting a cheery or olive to freezing custard to make ice cream. A general requirement for food prep is that the user must continuously supervise and monitor the appliances during use.

Individuals who enjoy cooking sauces, soups, noodles and other quality dishes understand the importance of either periodically or continuously stirring the dish. This may be time consuming for the cook, preventing them from preparing other items. Most cooks prepare their food items before they start cooking to ensure that they will not be distracted when necessary stirring begins. This requires the chef to be well organized before starting otherwise even small lapses in attention may cause the food to burn if left on the heat too long.

U.S. Pat. No. 5,201,263 by Andy C. Teng discloses a cooking utensil with built-in automatic stirring device wherein a cooking pot includes a built-in stirrer. The stirring device allows the contents of the pot to mix without requiring the user to stir. The stirring device includes a stirring blade on the bottom of the pot to mix the inner contents.

Alternatively, U.S. Pat. No. 6,113,258 by John Craig Ardent discloses a battery powered food stirrer with pivotally mounted spring biased arms. The food stirrer attaches to a vessel with a pair of arms attached to a lower portion of the stirrer. While both inventions provide automatic type stirring appliances, each only provide stirring means for the bottom of the pot. Even heat distribution is not attained.

It would be beneficial in the art to provide a stirring device that stirs itself without constant supervision from the user. It would also be desirable in the art to provide an automatic stirring device that mixes evenly throughout the cooking vessel.

### SUMMARY OF THE INVENTION

An object of the present invention is to provide a motorized cooking container that includes a stirring mechanism to allow the cooking container to stir itself independent from the user.

Another object of the present invention is to provide a stirring mechanism including a stirring means and a paddle to evenly distribute and mix the contents of the cooking container.

In view of the foregoing disadvantages inherent in the prior art, the purpose of the present disclosure is to provide an independent stirring cooking receptacle comprising a cooking container, where the cooking container receives a plurality of ingredients; a lid covering a top portion of the cooking container; a motor positioned above the lid; a rod extending from the motor and through a hole within the lid, where the rod is rotated by the motor; a stir shaft attached to a bottom portion of the rod, where the stir shaft rotates as the rod rotates; a stirring means attached to the stir shaft, where the stirring means mixes the plurality of ingredients; and a paddle fastened to a bottom portion of the stir shaft, where the paddle slides against a bottom of the cooking container and wherein the motor, the stirring means and the paddle enable the plurality of ingredients to mix without a user.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts a perspective view of an independent stirring cooking receptacle in accordance with an exemplary embodiment of the present invention;

FIG. 2 depicts a topside view of an independent stirring cooking receptacle in accordance with an exemplary embodiment of the present invention; and

FIG. 3 depicts a perspective view of a stir shaft in accordance with an alternative embodiment of the present invention.

Like reference numerals refer to like parts throughout the description of several views of the drawings.

### DETAILED DESCRIPTION OF THE DRAWINGS

The present invention relates to a motorized device that enables a cooking container to stir itself without the assistance and supervision of a user. The present invention provides an independent stirring cooking receptacle with an attached motor to power a stirring mechanism within a cooking container. The independent stirring cooking receptacle allows for continuous stirring without requiring the user to repeatedly stir the container. While cooking, the user may simply activate the stirring mechanism to mix the ingredients. Meanwhile the user is free to complete their other food preparations. The independent stirring cooking receptacle relieves the user from the responsibility of personally constantly stirring the ingredients, thereby providing them greater freedom to focus on other cooking activities.

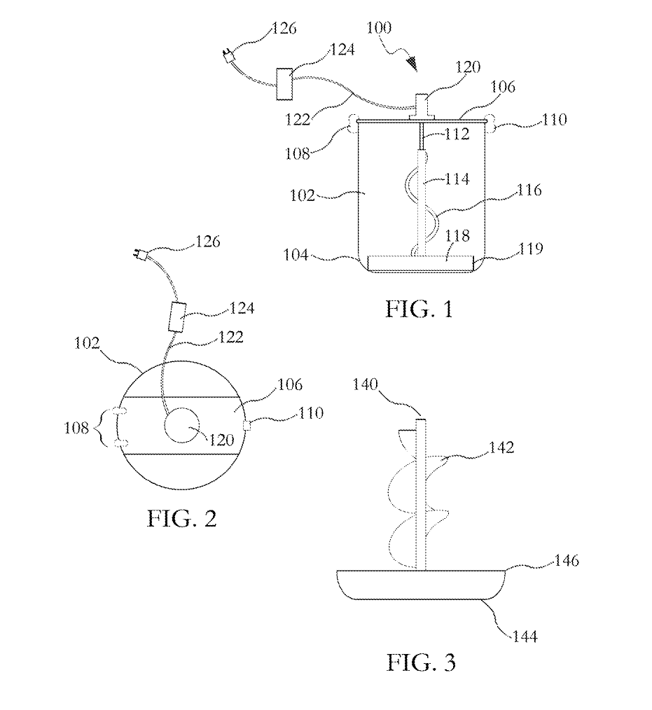

Tuning now descriptively to the drawings, referring to FIG. 1, a perspective view of an independent stirring cooking receptacle (100) is shown in accordance with an exemplary embodiment of the present invention. The independent stirring cooking receptacle (100) includes a cooking container (102) to receive a plurality of cooking ingredients. The cooking container (102) may be a pot, bowl, crock pot, saucepan, or similar cooking vessel, and may be made from stainless steel, copper or a nonstick material. At a base of the cooking container (102) is bottom (104). The bottom (104) may have square corners or curved corners depending on the make and style.

At a top portion of the cooking container (102) is a lid (106). The lid (106) may cover the entire opening of the cooking container (102) or it may only cover a portion (as shown in FIG. 2) of the opening. The lid (106) fastens to the cooking container (102) with a hinge (108) on one side and a latch (110) on an opposing side. The hinge (108) enables the lid (106) to open and close without detaching from the cooking container (102). Likewise, the latch (110) locks the lid (106) to the top of the cooking container (102) to prevent the lid (106) from detaching during use.

Positioned on top of the lid (106) is a motor (120). The motor (120) is removably fastened to the lid (106) to allow for convenience with storage and cleansing. The motor (120) provides the power and rotor to drive the independent stirring cooking container (100). The motor (120) may include a power switch for activation, and it may include a timer to allow the user to set a time period for the motor (120) to run.

Extending from the motor (120) into the cooking container (102) is a rod (112) that fits through a hole within the lid (106). The motor (120) powers the rod (112) by rotating it within the cooking container (102). Attached to a lower portion of the rod (112) is a stir shaft (114). The stir shaft (114) may detach from the rod (112) to allow alternative stirring attachments to be used, and to enable the stir shaft (114) to be cleaned. The stir shaft (114) may include a corkscrew bar (116) that spirals down the stir shaft (114). The corkscrew bar (116) rotates in the cooking container (102) to mix the plurality of cooking ingredients and distribute the heat.

Attached to a bottom portion of the shaft (114), below where the corkscrew rod (116) ends, is a paddle (118). The paddle (118) rotates along with the corkscrew rod (116) to mix the plurality of ingredients. The paddle (118) may have a square edge (119) to accommodate mixing in cooking containers with square corners or alternatively the paddle (118) may have a rounded edge (as shown in FIG. 3) to accommodate cooking containers with curved or rounded corners. The paddle (118) is positioned above the bottom (104) of the cooking container (102) so that it lightly slides against the bottom (104) without scraping or sticking. The paddle (118) may mix the plurality of ingredients that rest at the bottom (104) to prevent burning or clumping. To prevent scratching on the bottom of the cooking container (102), the paddle may be made from a food safe rubber that will not melt or distort when heated. The combination of the corkscrew rod (116) and the paddle (118) create an effective means to evenly distribute and mix the plurality of ingredients throughout the cooking container (102).

Turing focus to the top portion of the independent stirring cooking container, a power cord (122) with a plug (126) is attached to the motor (120) to enable the independent stirring cooking receptacle (100) to be plugged into an outlet. The power cord (122) may have a DC/AC converter (124) attached between the motor (120) and the plug (126). The power cord (122) allows the motor (120) to run for extended periods of time while cooking. Alternatively, the motor (120) may be powered by a battery pack housed within or next to the motor (120). The battery pack may accept conventional or rechargeable batteries for use. The battery pack allows the motor to portably operate without requiring that it remain close to the power outlet.

Referring now to FIG. 2, a topside view of the independent stirring cooking receptacle (100) is shown in accordance with an exemplary embodiment of the present invention. The lid (106) is illustrated only partially covering the cooking container (102). By exposing the opening of the cooking container (102) steam is able to escape during cooking. Alternatively, the lid (106) may be completely closed to prevent heat from escaping. The hinge (108) may have a single or double attachment (as shown) to secure the lid (106) to the cooking container (102). The double attachment hinge (108) may provide greater strength and stability for the lid (106) especially under the weight of the attached motor (120).

Referring to FIG. 3, a perspective view of a stir shaft (140) is shown in accordance with an alternative embodiment of the present invention. The stir shaft (140) provides an alternative attachment for the rod (112). The stir shaft (140) includes a helical blade (142) that spirals down to a paddle (144) attached to a bottom portion of the shaft (140). The helical blade (142) provides an alternative stirring means for the independent stirring cooking receptacle (100). The helical blade (142) may be made from metal or rubber depending on the preferences of a user. The paddle (144) includes a rounded edge (146) to accommodate cooking containers (102) with curved corners to prevent food from getting stuck or settling into the small crevices. The different stir shafts for the independent stirring cooking receptacle (100) provide the user options while cooking.

The cooking container may be available in a set of cookware providing different sizes of pots and pans. Each container may include a lid that accommodates the motor, rod and stir shaft. Since the motor and the stir shaft are detachable, the pieces may be interchanged on the various cooking containers. The stir shafts may be available in multiple lengths to fit the various heights of the cooking containers included in the set.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. An independent stirring cooking receptacle comprising:
a cooking container, where said cooking container receives a plurality of ingredients;
a lid covering a top portion of said cooking container;
a motor positioned above said lid;
a rod extending from said motor and through a hole within said lid, where said rod is rotated by said motor;
a stir shaft attached to a bottom portion of said rod, where said stir shaft rotates as said rod rotates;
a stirring means attached to said stir shaft, where said stirring means mixes said plurality of ingredients; and
a paddle fastened to a bottom portion of said stir shaft, where said paddle slides against a bottom of said cooking container and wherein said motor, said stirring means and said paddle enable said plurality of ingredients to mix without a user.

2. The independent stirring cooking receptacle according to claim 1, wherein said stirring means is a corkscrew bar that spirals down said stir shaft.

3. The independent stirring cooking receptacle according to claim 1, wherein said stirring means is a helical blade that spirals down said stir shaft.

4. The independent stirring cooking apparatus according to claim 1, wherein said motor includes a power cord and a plug to enable said motor to plug into an outlet.

5. The independent stirring cooking apparatus according to claim 1, wherein said motor includes a battery pack for power.

6. The independent stirring cooking apparatus according to claim 1, wherein said lid includes a hinge attached to an edge to enable said lid to lift and lower without detaching from said cooking container.

7. The independent stirring cooking apparatus according to claim 6, wherein said lid further includes a latch to lock said lid to said cooking container.
